(19) United States
(12) Patent Application Publication
(10) Pub. No.: US 2014/0027692 A1
(43) Pub. Date: Jan. 30, 2014

(54) DEVICE FOR REMOVING HOPPERS FROM RAIL CARS

(71) Applicant: VALE S/A, Rio de Janeiro (BR)

(72) Inventor: Célio Antonio GUIMARÃES, Arreao (BR)

(73) Assignee: VALE S/A, Rio de Janeiro (BR)

(21) Appl. No.: 13/951,267

(22) Filed: Jul. 25, 2013

(30) Foreign Application Priority Data
Jul. 25, 2012 (BR) PI 102012018472-9

(51) Int. Cl. B66D 1/28

(52) U.S. Cl. CPC B66D 1/28
USPC 254/334

(57) ABSTRACT

There is described a device for removing a drawer-type hopper of a railroad car, the device comprising: a first support base positioned on a platform and a second support base supported on the railroad car; and a tackle fastened on the first support base; the tackle comprising a first hook associated to the drawer-type hopper, the first hook and the drawer-type hopper being moved linearly by the tackle in the opposite direction of the railroad car.

The present invention refers to a device for removing hoppers in a bulk railroad car, particularly draw-type hoppers, after unloading the load.

### DESCRIPTION OF THE STATE OF THE ART

Certain railroad cards comprise drawer-type hoppers, used for unloading the transported load, especially bulk cars.

During maintenance of these bulk cars, there is a notable need to change the draw-type hopper and, in such cases, the hopper is removed in a dangerous and time-consuming manner, with the use of blowtorches and mallets, demanding extreme physical effort from the professional and retaining the car in the maintenance for a very long period of time.

Therefore, it is not known from the prior art a device for removing draw-type hoppers from bulk cars in an efficient and safe manner. Devices applied to hoppers already known in the state of the art are designed to assist or facilitate unloading, but not the removal thereof from the car. In this sense, document GB190307990, for example, describes a mechanism to operate lower doors of hopper cars for unloading the material inside them. This mechanism comprises an articulation fixed to the door and a pulley, linked to this articulation by means of a chain. However, this document does not teach the removal of draw-type hoppers.

Document US2007/089638 describes a mechanism for automatically opening or closing the covers of hopper railroad cars. This mechanism is formed by articulated bars which contact the covers for unloading the content of the cars. Despite achieving the aim of automatically operating the hopper covers, this mechanism is not used to remove drawer-type hoppers in a railroad car.

Document US2006/000384 refers to a system for automatically operating hopper doors. This system is formed by articulated arms and actuating cylinders. However, just like the mechanism above, this system is only for opening hopper doors.

### OBJECTIVES OF THE INVENTION

The objective of the present invention is to provide a device for removing a drawer-type hopper of a railroad car in a safe, practical, rapid and efficient manner, reducing the time to replace this hopper and, consequently, reducing the downtime of the car for maintenance.

### BRIEF DESCRIPTION OF THE INVENTION

The object of the invention is a device for removing a drawer-type hopper from a railroad car, the device comprising: a first support base positioned on a platform and a second support base supported on the railroad car; and a tackle fastened on the first support base; the tackle comprising a first hook associated to the drawer-type hopper, the first hook and the drawer-type hopper being moved linearly by the tackle in the opposite direction of the railroad car.

### DESCRIPTION OF THE DRAWINGS

The present invention will now be described in greater detail based on an example of execution represented in the drawings. The drawings show:

FIG. 1—is a front view of the device that is the object of the present invention;

FIG. 2—is a detailed view of the action of the device, object of this invention, in the drawer-type hopper;

FIG. 3—is a detailed view of the device, object of this invention, removing the drawer-type hopper from the railroad car; and

FIG. 4—is a detailed view of the device, object of this invention, finalizing the removal of the drawer-type hopper from the railroad car.

### DETAILED DESCRIPTION OF THE DRAWINGS

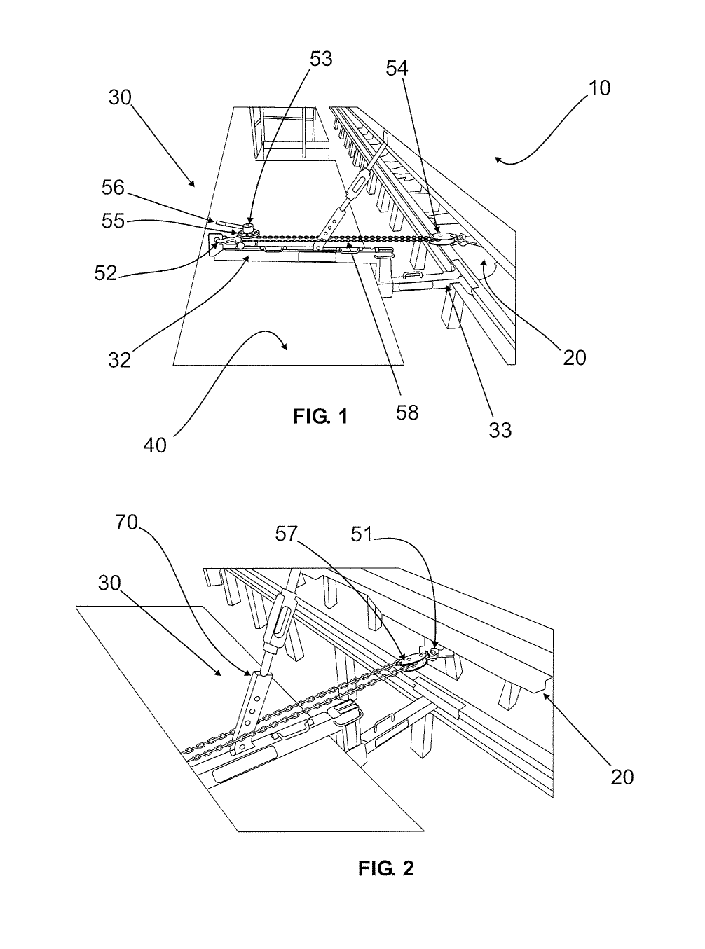

According to a first embodiment and as can be seen as of FIG. 1, the present invention refers to a mechanical device 30 for removing a drawer-type hopper 20 of a railroad car 10.

This device 30 comprises a first support base 32 positioned on a platform 40 and a second support base 33 supported on the railroad car 10, both preferably manufactured with hardened metallic profiles.

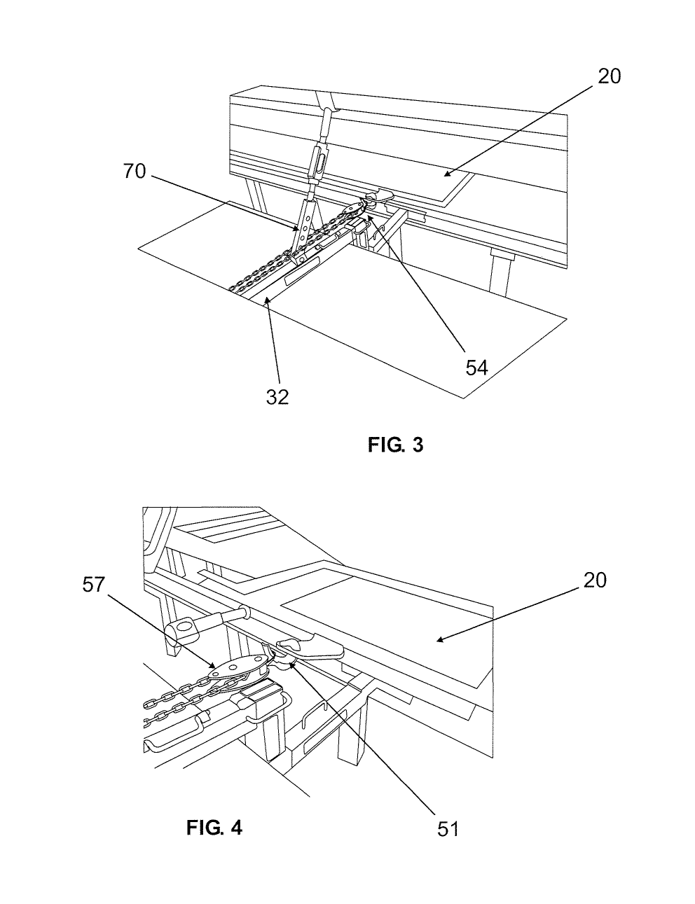

The device 30 further comprises a tackle 50 fastened on the first support base 32. As illustrated in FIG. 1 and in the details of FIGS. 2 to 4, the tackle 50 contains a drag mechanism 54 fastened to the drawer-type hopper 20 by means of a first hook 51 and an arm mechanism 53 fastened on the first support base 32 by means of a second hook 52.

The arm mechanism 53 is formed by a turnstile 55 driven by an arm 56. The drag mechanism 54 is formed by a pulley 57 fastened to the first hook 51. A chain 58 cooperatively associates the arm mechanism 53 to the drag mechanism 54. The chain 58 is inserted into the turnstile 55 and passes through the groove of the pulley 57, whereby the chain 58 is coiled around the body of the turnstile 55 when driven.

The device 30 also comprises a supporting element 70 disposed substantially concurrent to the first support base 32 and supported on the railroad car 10.

When it is necessary to change the drawer-type hopper 20 of a bulk railroad car 10, this car 10 is parked next to a maintenance platform 40. The device 30 for removing the drawer-type hopper 20 of a railroad car 10, the object of this invention, is positioned next to the car 10 such that the first support base 32 of the device 30 is positioned on a platform 40 and the second support base 33 is supported on the railroad car 10. Additionally, the supporting element 70 is also supported on the car 10, preferably on the corner of the juncture of the side wall with the bottom or floor of the car 10.

Once the device 30 is firmly positioned, the arm mechanism 53 is fastened on the first support base 32 of the device by way of the second hook 52. Optionally, the arm mechanism 53 may be fastened to the first support base 32 of the device 30 before positioning this device 30 on the platform 40.

Next, the pulley 57 of the drag mechanism 54 is associated to the drawer-type hopper 20 by encasing the first hook 51 in an eyelet contained in the drawer-type hopper 20, finalizing the assembly of the device 30 as illustrated in FIG. 1.

The operator moves the arm 56 rotating the turnstile 55. In being rotated, the turnstile 55 drives the chain 58 which coils around the body of the turnstile 55, and during the recoiling of the chain 58 there occurs traction of the drag mechanism 54. As the drag mechanism 54 is associated to the hopper 20 by means of the first hook 51, the first hook 51 and the drawer-type hopper 20 are moved linearly by the tackle 50 in the opposite direction of the railroad car 10, that is, in the direction of removing the drawer-type hopper 20 from its compartment in the railroad car 10.

During this hopper 20 removal procedure, the supporting element 70 prevents the first support base 32 from losing contact with the platform 40 while traction force is being applied to the chain 58 and to the drag mechanism 54 by the arm mechanism 53.

With the use of this device 30, the time spent on removing hoppers 20 from railroad cars 10 is significantly reduced from 40 minutes to 10 minutes. This generates an increase in productivity. Using methods already known in the state of the art, the production capacity is 8 hoppers removed from 2 cars per day. The use of the device 30, object of this invention, enables production of replacing 24 hoppers removed from 6 cars per day. Consequently, the car retention time for replacing the hoppers is already reduced, whereby increasing the productivity index.

Additionally, the device 30 provides much more safety in the activity, since mallets and blowtorches are not used.

Having described an example of a preferred embodiment, it must be understood that the scope of the present invention encompasses other possible variations, being limited only by the content of the accompanying claims, potential equivalents being included therein.

1. A device for removing a drawer-type hopper from a railroad car, the device comprising:
a first support base positioned on a platform and a second support base supported on the railroad car; and
a tackle fastened on the first support base;
the tackle comprising a first hook associated to the drawer-type hopper, the first hook and the drawer-type hopper being moved linearly by the tackle in the opposite direction of the railroad car.

2. The device as claimed in claim 1, wherein the tackle comprises an arm mechanism fastened on the first support base by a second hook and a drag mechanism fastened to the drawer-type hopper by the first hook.

3. The device as claimed in claim 2, wherein the arm mechanism comprises a turnstile driven by an arm and the drag mechanism comprises a pulley, and further comprising a chain that cooperatively associates the arm mechanism to the drag mechanism.

4. The device as claimed in claim 1, further comprising a supporting element disposed substantially concurrent to the first support base and fastened to the railroad car.
